(19) United States
(12) Patent Application Publication
(10) Pub. No.: US 2013/0235085 A1
(43) Pub. Date: Sep. 12, 2013

(54) METHOD OF PROVIDING DYNAMIC MULTI-VISION SERVICE

(71) Applicants: Sung Hee KIM, Daejeon (KR); Cheol-Hye Cho, Daejeon (KR); Won Ryu, Daejeon (KR)

(72) Inventors: Sung Hee KIM, Daejeon (KR); Cheol-Hye Cho, Daejeon (KR); Won Ryu, Daejeon (KR)

(73) Assignee: ELECTRONICS AND TELECOMMUNICATIONS RESEARCH INSTITUTE, Daejeon (KR)

(21) Appl. No.: 13/571,627

(22) Filed: Aug. 10, 2012

(30) Foreign Application Priority Data
Mar. 12, 2012 (KR) 10-2012-0025254

(51) Int. Cl. G09G 5/00

(52) U.S. Cl. 345/660

(57) ABSTRACT

The present invention provides a method of providing dynamic multi-vision service, including detecting, by a main screen device, a surrounding auxiliary screen device, distributing an image signal to the auxiliary screen device when the auxiliary screen device is detected, scaling, by each of the main screen device and the auxiliary screen device, the image signal based on multi-vision region information, and displaying, by the main screen device and the auxiliary screen device, the image signal after being synchronized with each other.

### CROSS-REFERENCES TO RELATED APPLICATIONS

The present application claims priority under 35 U.S.C 119(a) to Korean Application No. 10-2012-0025254, filed on Mar. 12, 2012, in the Korean Intellectual Property Office, which is incorporated herein by reference in its entirety set forth in full.

### BACKGROUND

Exemplary embodiments of the present invention relate to a method of providing dynamic multi-vision service, and more particularly, to a method of providing dynamic multi-vision service, which dynamically provides multi-vision service by distributing an image, displayed in a main screen, to other auxiliary screens adjacent to the main screen up, down, left, and right when the auxiliary screens approach the main screen in the up, down, left, and right directions in an environment in which N-screen service is possible.

In general, multi-vision enables an image outputted to the small screen of a portable terminal, enabling Television (TV) or image service, to be watched through a large screen. This multi-vision has a large-sized screen effect by using a function of consecutively outputting several screens as one image or of outputting the same image to each of screens. The multi-vision is chiefly installed in outdoor display devices, display devices at exhibition halls or events, and display device at singing rooms, and it provides service that provides people with simultaneous looking and listening or enables people to use information.

A multi-vision system includes a plurality of display devices, an intermediate image signal distribution device (or a control device), and additional Audio/Video (A/V) output devices. Codec and transmission technology, image splitting technology, scaling technology according to a screen size and quality, information processing technology for coordinates at which screens are placed and image splitting areas, and sync technology between screens are used in the multi-vision system. Near-field communication network technology for an exchange of pieces of information between a main screen and auxiliary screens is recently being used in the multi-vision system.

The multi-vision system has recently developed into the service and technology fields in which multi-content can be shared and executed anywhere anytime through smart screen devices (e.g., smart phones, tablets, IPTV, and smart TV) and, in an N-screen service environment in which a seamless view is possible, a screen being used by a user is operated in conjunction with other screens through the same User Experience (UI) and content being watched can be consecutively displayed along with other screens.

For example, when content is broadcasted from Internet Protocol TV (IPTV) or smart TV, if a smart phone or tablet approaches a TV screen, that is, a main screen up, down, left, and right, the screens may be gathered and dynamically formed into one large screen, thereby being capable of providing multi-vision service. As another application, when a user watches multi-vision service formed of a multi-screen and moves outside, that is, when a distribution relation is broken, the content of a main screen continues to be streamed to screens and then outputted so that the streaming of the content is not broken. Accordingly, the user may continue to use the content through the screens.

In the existing N-screen service, a person chiefly wants to enjoy seamless service by independently using several terminals. Thus, files and content sharing between terminals, mirroring, a seamless view of content using another terminal, etc. have become major and kernel services.

Triple services (i.e., broadcasting, communication, and Internet) are now provided through IPTV, a Personal Computer (PC), and a mobile phone according to a characteristic of a service provider. A task of expanding the triple services to multiple terminals is primarily performed based on the homogeneous platform. Representative examples include the Android platform and the iPhone OS (IOS) platform. N-screen service may be relatively easily realized in terminals having the Android and IOS platforms embedded therein, and N-screen service between heterogeneous platforms is confined to a level that solves a mobility problem. From a viewpoint of an N-screen service progress step, at the present stage, a storage-based data sharing and synchronization step has been activated (first step), the present stage gradually proceeds to a next step in which the same media content enabling Internet access may be divided and watched (second step), and it is expected that the next step will proceed to a service realization step associated with optimized service movement according to a terminal characteristic and multiple terminals.

Meanwhile, as the number of screens (i.e., terminals) carried by a person increases, techniques regarding user interfaces and experiences in which a screen may be shared and several users may properly use several devices are getting into the spotlight. This leads to a demand that service performed between multiple terminals should be used through the same UI and User Experience (UX) as possible. To this end, four types, that is, a keyboard, a pointer, a gesture, and voice and multi-touch technology in which the four types are combined are attracting user's interest. In particular, if the same UI/UX are provided in an environment in which not only IPTV, smart TV, a smart phone, and a smart tablet, but also a home network device and a home security device coexist in a narrow space (e.g., a space within a distance of 10 feet), such as a home, there is an opportunity that may spread N-screen service and also maximize social service because an easy interaction is provided between users.

The existing multi-vision system includes image signal input devices, such as a video player and a DVD player, a plurality of screen devices, such as an image displayer, an image terminal, a display device, a display module, an image display device, and a stereographic image display device, and an intermediate image signal control device (i.e., an intermediate image signal distribution device) for coupling the image signal input devices and the plurality of screen devices and properly distributing, splitting, reducing, and scaling up an image signal, provided by the image signal input device, to relevant screen devices.

The existing multi-vision control method includes a method of previously fixing the number and position of screens participating in multi-vision and display regions by manually manipulating an intermediate image signal control device and properly distributing an image to screens at respective positions and a method of previously checking, by a main screen, auxiliary screens participating in multi-vision through a wireless protocol, such as Bluetooth, and properly distributing an image to screens at respective positions.

Furthermore, image scaling technology, signal distribution and control technology, signal lost-prevention and overcoming technology, inter-screen sync technology, inter-screen spacing display technology, multi-vision screen configuration technology, and system operating technology which are necessary to provide multi-vision through the above methods have been developed in various ways and supplied as specific multi-vision systems.

Most of the conventional multi-vision systems provide service in such a manner that an image signal input device, an intermediate signal control device, and a plurality of screen devices are coupled using serial or parallel cables. There has also disclosed technology for configuring a multi-vision system in which an intermediate signal control device is embedded in a screen device by taking installation conditions, production and operating costs, and image signal loss prevention into consideration.

Furthermore, unlike technology for configuring a multi-vision system using fixed screens, technology for splitting a broadcasting screen received through portable terminals and displaying the split screens in a plurality of portable terminals so that the limit of a small-sized display device can be overcome and broadcasting can be watched through a larger screen has also been disclosed. In this case, Bluetooth, UWB, Zig-Bee, and Wireless 1394 are being used as near-field wireless technology. Here, if a broadcasting image is split into a plurality of images, the first split image is displayed in a user's portable terminal, and the split images are transmitted to a relevant sub-terminal through near-field wireless communication, a multi-vision function of displaying one broadcasting image in a plurality of portable terminals is provided. In this case, there have been disclosed a method of configuring a multi-vision system including an intermediate signal control device and portable terminals and a method of wirelessly coupling portable terminals in a master-slave structure without using an additional intermediate signal device function.

For background technology related to the present invention, reference may be made to Korean Patent Laid-Open Publication No. 10-2011-0003964 (disclosed on Jan. 13, 2011) entitled ‘System and Method for Multi-Screen Mobile Convergence Service’.

### SUMMARY

In the master-slave method technology for providing multi-vision service using conventional portable terminals, however, there is a problem in that a processing load of a terminal designated as a master increases as the number of auxiliary screens increases. Furthermore, when a master is changed, processing costs necessary to reorganize a master-slave information structure and to synchronize terminals are generated.

Furthermore, if the number and direction of users are randomly increased or reduced without designating the number and position of auxiliary screens as planned, it is necessary to dynamically adjust the dimension of multi-vision according to the number of increased or reduced screens while maintaining an already formed multi-vision image.

An embodiment of the present invention relates to a method of providing dynamic multi-vision service, in which, when the positions of auxiliary screen devices are dynamically designated in such a manner that the auxiliary screen devices are brought close to or separated from a main screen device up, down, left, and right, one multi-vision screen is configured through the main screen device and the auxiliary screen devices by sensing the dynamic designation.

Another embodiment of the present invention relates to embedding an intermediate signal control function in an IPTV Set-top Box (STB) or smart TV and converging dynamic position sensing User Experience (UX) and collaboration between screens for the discovery of screen devices participating multi-screen service, synchronization between screen devices, screen quality adjustment according to a screen device characteristic, and the transmission of an image signal to a next screen device.

Yet another embodiment of the present invention relates to enabling users to freely use multi-vision service as a group in a home, an office, a conference room, or game according to the conditions of the users by configuring IPTV or smart TV as a main screen device and configuring portable smart devices as sub-players.

Further yet another embodiment of the present invention relates to enabling users to use the same multi-vision service through only a screen device in a sports ground or outdoors. Accordingly, since users may configure a large-sized screen in various forms according to their intentions, a sense of satisfaction of users according to the use of a multimedia scenario can be improved, and thus new content may be developed based on a multi-terminal/multi-screen.

Still yet another embodiment of the present invention relates to extending portable terminal multi-vision service, limited and disclosed to the existing DMB mobile terminals or feature phones, all smart devices, thereby being capable of providing differentiated service in an N-screen environment.

In one embodiment, a method of providing dynamic multi-vision service, including detecting, by a main screen device, a surrounding auxiliary screen device; when the auxiliary screen device is detected, generating, by the main screen device, multi-vision region information defining a multi-vision image region where the main screen device and the auxiliary screen device will display an image signal; distributing, by the main screen device, the image signal to the auxiliary screen device; and scaling and displaying, by each of the main screen device and the auxiliary screen device, the image signal based on the multi-vision region information.

In the present invention, in the scaling and displaying of the image signal, the main screen device scales an image signal to be outputted from the main screen device by the multi-vision region and displays the scaled image signal.

In the present invention, in the scaling and displaying of the image signal, the auxiliary screen device calibrates the image signal, distributed by the main screen device, according to a profile of the auxiliary screen and displays the calibrated image signal.

In the present invention, the method further includes recognizing, analyzing, and updating, by the main screen device and the auxiliary screen device, the type, number, and position of the main screen device and the auxiliary screen device through an object recognition function.

In the present invention, the position of the auxiliary screen device is detected through a motion occurring around the main screen device based on the position of the main screen device.

In the present invention, the scaling and displaying of the image signal includes displaying, by the main screen device, the image signal in a full image form and then displaying, by the auxiliary screen device, the image signal according to the multi-vision region.

In the present invention, in the scaling and displaying of the image signal, the auxiliary screen device receives the multi-vision region from the main screen device, re-calibrates the image signal according to the multi-vision region, and displays the re-calibrated image signal.

In the present invention, the scaling and displaying of the image signal comprises changing a form of the image signal, outputted to the main screen device and the auxiliary screen device, according to a user's gesture.

In the present invention, the main screen device and the auxiliary screen device integrate the image signals and output the integrated image signal or individually output the image signals according to the gesture.

### BRIEF DESCRIPTION OF THE DRAWINGS

The above and other aspects, features and other advantages will be more clearly understood from the following detailed description taken in conjunction with the accompanying drawings, in which:

FIG. 1 is a diagram showing an example in which content is extended and outputted when auxiliary screens are spatially connected to the left side of a main screen according to an embodiment of the present invention;

FIG. 2 is a diagram showing an example in which content is extended and outputted when auxiliary screens are spatially connected to the right side of a main screen according to an embodiment of the present invention;

FIG. 3 is a diagram showing an example in which content is extended and outputted when auxiliary screens are spatially connected to the up, down, left, and right sides of a main screen according to an embodiment of the present invention;

FIG. 4 shows a construction of an apparatus for providing dynamic multi-vision service according to an embodiment of the present invention; and

FIG. 5 is a flowchart illustrating a method of providing dynamic multi-vision service according to an embodiment of the present invention.

### DESCRIPTION OF SPECIFIC EMBODIMENTS

Hereinafter, embodiments of the present invention will be described with reference to accompanying drawings. However, the embodiments are for illustrative purposes only and are not intended to limit the scope of the invention.

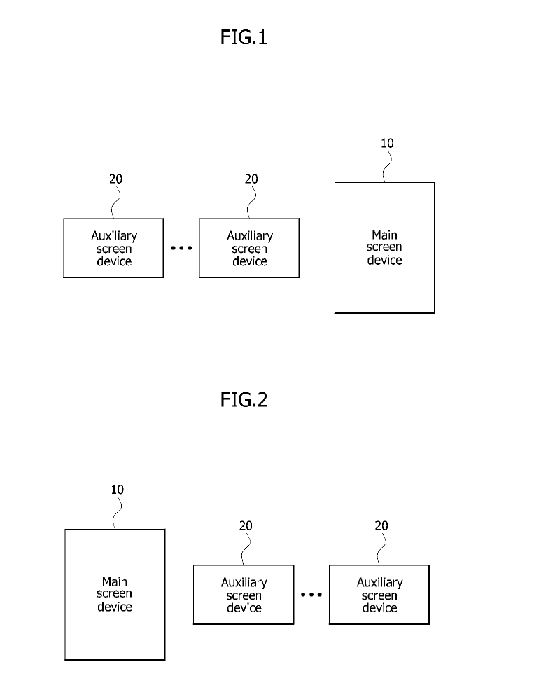

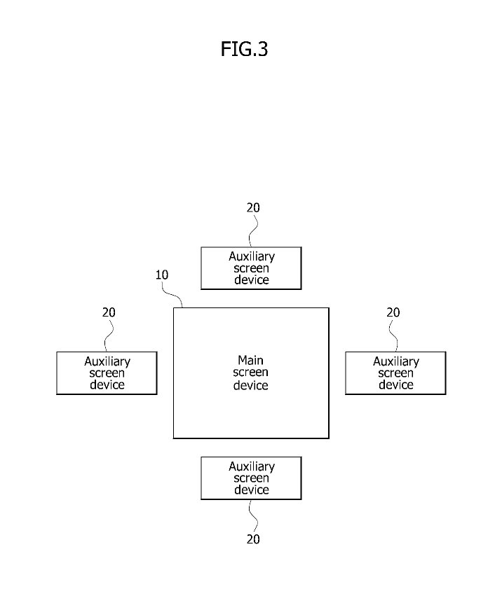

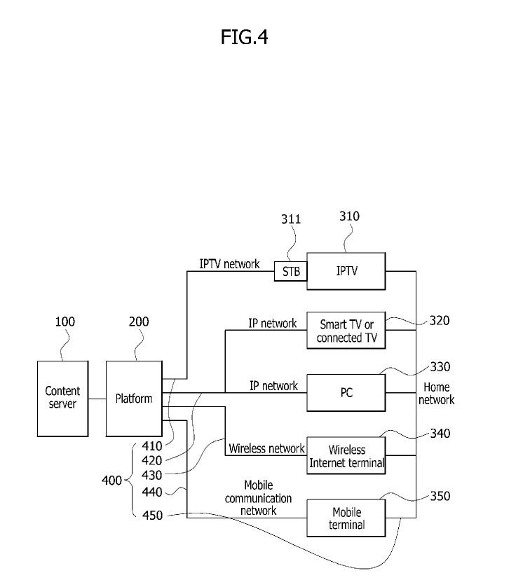

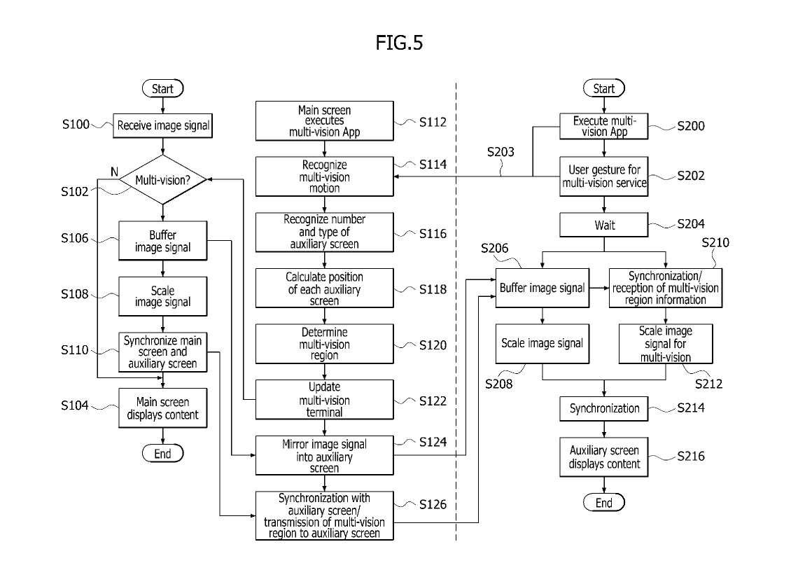

FIG. 1 is a diagram showing an example in which content is extended and outputted when auxiliary screens are spatially connected to the left side of a main screen according to an embodiment of the present invention, FIG. 2 is a diagram showing an example in which content is extended and outputted when auxiliary screens are spatially connected to the right side of a main screen according to an embodiment of the present invention, FIG. 3 is a diagram showing an example in which content is extended and outputted when auxiliary screens are spatially connected to the up, down, left, and right sides of a main screen according to an embodiment of the present invention, and FIG. 4 shows a construction of an apparatus for providing dynamic multi-vision service according to an embodiment of the present invention.

The method of providing dynamic multi-vision service according to the embodiment of the present invention provides dynamic multi-vision service in which an image signal displayed in a main screen device 10 is distributed and streamed to one or more auxiliary screen devices 20 approaching in one or more of the up, down, left, and right directions when the one or more auxiliary screen devices 20 approach the main screen device 10 in one or more of the up, down, left, and right directions in an environment in which N-screen service is possible.

Here, the main screen device 10 may be formed of one or more of IPTV 310, smart TV or connected TV 320, a PC 330, a wireless Internet terminal 340, and a mobile terminal 350. The auxiliary screen device 20 may be formed of one or more of the IPTV 310, the smart TV or connected TV 320, the PC 330, the wireless Internet terminal 340, and the mobile terminal 350. Furthermore, the auxiliary screen device 20 may be plural.

In the method of providing dynamic multi-vision service according to the embodiment of the present invention, as shown in FIG. 1, in a process in which the main screen device 10 plays content, when the auxiliary screen device 20 approaches the main screen device 10 from the left side, an image signal of content displayed to the main screen device 10 is distributed to the relevant auxiliary screen device 20 and displayed in the relevant auxiliary screen device 20. Moreover, when another auxiliary screen device 20 approaches the auxiliary screen device 20 from the side, the image signal of the main screen device 10 is also distributed and outputted to another auxiliary screen device 20.

Furthermore, as shown in FIG. 2, when the auxiliary screen device 20 approaches the main screen device 10 from the right side, content outputted from the main screen device 10 is extended and outputted to the relevant auxiliary screen device 20.

In addition, as shown in FIG. 3, when the auxiliary screen devices 20 approach the main screen device 10 not only left and right, but also up and down, an image signal displayed in the main screen device 10 is distributed and displayed up, down, left, and right.

Here, an image displayed to the main screen device 10 is extended in order of images streamed up, down, left, and right. After an integrated screen in which the main screen device 10 and a plurality of the auxiliary screen devices 20 are combined is completed, all the main screen device 10 and the auxiliary screen devices 20 may be arranged in a form, such as screen refresh, and outputted. This illustration is partially shown in order to describe the present invention, and various types of combinations of the screen devices 10 and 20 are also possible.

An apparatus for providing dynamic multi-vision service according to an embodiment of the present invention is described below with reference to FIG. 4.

The apparatus for providing dynamic multi-vision service according to the embodiment of the present invention streams and distributes an image, displayed in the main screen device 10, to one or more other auxiliary screen devices 20 approaching in one or more of the up, down, left, and right directions when the one or more auxiliary screen devices 20 approach the main screen device 10 in one or more of the up, down, left, and right directions. The apparatus include a content server 100, a platform 200, the screen devices 10 and 20, and a network 400.

For reference, in the present embodiment, the content server 100 provides content to a user. The content server 100 may provide content to a user in various ways. For example, the content server 100 may provide content by using a method unique to each service provider, may provide content in an open market form, or may provide content in a cloud manner.

The platform 200 processes content, received from the content server 100, in a form suitable for environments of the network 400 and the screen devices 10 and 20 and broadcasts or transfers the processed content. The platform 200 also provides media convergence services requested by a user, such as various bidirectional service, multimedia service, mobility service, and social service.

Here, the platform 200 also includes an open type service platform in addition to a platform unique to a service provider.

The network 400 transfers content from the platform 200 to the screen devices 10 and 20, transfers an image signal between the main screen device 10 and the auxiliary screen device 20, or transfers an image signal between the auxiliary screen devices 20. The network 400 may include an IPTV network 410 guaranteeing Quality of service (QoS), an IP network 420 providing only Best-effort QoS, a wireless network 430 providing wireless service, such as Wi-Fi, a mobile communication network 440 providing one or more of 2G, 3G, and 4G mobile communication services, and a home network 450 utilizing Universal Plug and Play (uPnP) or Digital Living Network Alliance (DLNA).

The screen devices 10 and 20 output an image signal of content transmitted by the platform 200 and also distribute, share, and play image signals from other screen devices 10 and 20. The screen devices 10 and 20 may be the main screen devices 10 or the auxiliary screen devices 20 according to a multi-vision service environment.

The screen devices 10 and 20 include the IPTV 310, the smart TV or connected TV 320, the PC 330, the wireless Internet terminal 340 equipped with a wireless network interface, and the mobile terminal 350 equipped with a mobile communication network interface. The mobile terminal 350 includes a smart phone or a smart tablet.

Here, the IPTV 310 has a Set-Top Box (STB) 311 embedded therein, and the smart TV or connected TV 320 has the function of the STB 311 embedded therein. The PC 330, the wireless Internet terminal 340, and the mobile terminal 350 using broadcasting also have the function of the STB 311 embedded therein in hardware or software.

In the apparatus for providing multi-vision service according to the embodiment of the present invention, the wireless Internet terminal 340 or the mobile terminal 350 may be adopted as the main screen device 10. To this end, dynamic multi-vision service functions may be embedded in the wireless Internet terminal 340 or the mobile terminal 350 so that service according to the present embodiment is possible. Furthermore, the illustrated system configuration may be well operated in N-screen and cloud environments.

A method of providing dynamic multi-vision service according to an embodiment of the present invention is described in detail with reference to FIG. 5.

FIG. 5 is a flowchart illustrating the method of providing dynamic multi-vision service according to the embodiment of the present invention.

For reference, in the present embodiment, software installed in the main screen device 10 and the auxiliary screen device 20 is implemented using any one of a web method, an Application (App) method, and a hybrid web App method in which the web method and the App method are converged. The software may be implemented in various ways according to a terminal environment or user preference.

First, when the main screen device 10 is powered on, the main screen device 10 receives content of a digital image from the platform 200 over the network 400 at step S100 and displays the image signal at step S104.

Here, the main screen device 10 detects the auxiliary screen device 20. In this case, the main screen device 10 executes a main screen multi-vision App installed therein at step S112 and configures multi-vision along with the auxiliary screen device 20.

Here, the main screen multi-vision App may be automatically executed when the main screen device 10 is booted or may be separately executed by a user. Here, if the main screen device 10 is the smart TV 320, the main screen multi-vision App may be embedded in the smart TV 320 so that it is executed within the smart TV 320. If the main screen device 10 is the IPTV 310, the main screen multi-vision App may be implemented in the STB 311.

When the main screen multi-vision App is executed as described above, the main screen device 10 checks whether the auxiliary screen device 20 approaches the main screen device 10 at step S114.

Here, the auxiliary screen device 20 has an auxiliary screen multi-vision App, corresponding to the main screen multi-vision App, embedded therein and executes the auxiliary screen multi-vision App. For user convenience and system performance, a user may manually execute the auxiliary screen multi-vision App whenever multi-vision service is necessary.

For example, a function of executing the auxiliary screen multi-vision App in the auxiliary screen device 20 may be implemented in such a manner that an interface, such as a multi-vision icon, is generated in the smart terminal 350 and the auxiliary screen multi-vision App is executed when a user touches the interface. Here, an ID and password, such as e-mail, may be inputted, for security purposes. For a more detailed and safer method, a specific user and terminal certification procedure may be introduced and operated in conjunction with the auxiliary screen multi-vision App.

The recognition of a multi-vision motion refers to the recognition of a user's gesture. For example, when a user indicates a specific shape toward the main screen device 10 using his finger, the main screen device 10 may analyze the specific shape and process a task relevant to the enlargement or reduction of multi-vision at steps S112 and S114.

Multi-vision is configured when a user brings the auxiliary screen device 20 close to the main screen device 10 at positions close to the up, down, left, and right directions of the main screen device 10. At this time, the auxiliary screen device 20 transmits its profile information to the main screen device 10 in the form of a UI stream, and the main screen device 10 may manage the recognized auxiliary screen device 20 at step S203.

Here, each of the auxiliary screen multi-vision App and the main screen multi-vision App has an object recognition function in which a camera, a compass, an acceleration sensor, and a gyroscope sensor are converged embedded therein. Each of the auxiliary screen multi-vision App and the main screen multi-vision App recognizes the type, number, and position of the main screen device 10 and the auxiliary screen device 20 which request service, analyzes the type, number, and position, and updates a multi-vision terminal database (not shown).

Furthermore, the multi-vision terminal database basically includes profile information about each of the screen devices 10 and 20 as well as a screen size for each type. The multi-vision terminal database constructs and manages a service database whenever the main screen device 10 or the auxiliary screen device 20 requests multi-vision service based on the profile information.

The main screen device 10 recognizes the number and type of the auxiliary screen device 20 by using a camera (not shown) embedded therein at step S116. In this case, the type of the recognized auxiliary screen device 20 is compared with information stored in the multi-vision terminal database for identification, and the number of services is counted as many as the number of recognized auxiliary screen devices 20.

Furthermore, information about the direction of the auxiliary screen device 20 may be detected by a sensor application provided by the main screen multi-vision App and may be used as multi-vision region information at step S118.

The main screen device 10 determines multi-vision image regions to be displayed by the auxiliary screen devices 20, participating in multi-vision service, through the above process at step S120 and updates pieces of information about the determined multi-vision image regions by incorporating the pieces of information into the multi-vision terminal database in real time at step S122.

Accordingly, when the positions of the auxiliary screen devices 20 approaching the main screen device 10 in the up, down, left, and right directions of the main screen device 10, that is, the positions of the auxiliary screen devices 20 according to a user motion on the basis of information about the position of the main screen device 10 are detected, the main screen device 10 starts buffering a digital image being displayed by the main screen device 10, that is, an image signal in order to transmit the image signal the auxiliary screen devices 20 at step S106 and scales the image signal to be displayed by its multi-vision image regions at step S108.

Furthermore, the main screen device 10 is synchronized with the auxiliary screen devices 20 that will participate in multi-vision service at step S110 and then displays the image signal at step S104.

Meanwhile, a task of copying the buffered image signal to all the auxiliary screen devices 20 participating in multi-vision service is performed because the buffered image signal has to be transmitted to the auxiliary screen devices 20. The copied image signal is transmitted over a WLAN or Bluetooth and the ability of a mobile communication network according to standard media streaming methods, such as uPnP, DLNA, and H.264. This transmission may be implemented by using media streaming functions provided by the smart TV 320 or the mobile terminal 350. Furthermore, synchronization information and multi-vision region information between the main screen device 10 and the auxiliary screen devices 20 which participate in multi-vision service are transmitted and received through UI/UX context at step S126.

When the auxiliary screen device 20 executes the auxiliary screen multi-vision App, the multi-vision service is started.

A method of starting the multi-vision service may be implemented in such a manner that an interface, such as a multi-vision icon, is generated and the multi-vision service is executed when a user clicks on the interface as described above. Likewise, an ID and password, such as e-mail, may be inputted for safety, and a specific user and terminal certification procedure may be introduced and operated in conjunction with the multi-vision service for a more detailed and safer method at step S200.

In order to configure multi-vision in such a way to be streamed from the main screen device 10, a user moves the smart terminal 350, now being used, in the up, down, left, and right direction of the main screen device 10 of a main screen through hits motion at step S202.

Next, the smart terminal 350 receives and buffers the image signal transmitted from the main screen device 10 at step S206 and calibrates the image signal based on the profile of the smart terminal 350 of an auxiliary screen at step S208.

Next, the smart terminal 350 is synchronized with the main screen device 10 at step S214, and it displays the scaled image signal in its screen at step S216.

In this case, for example, the full image of the main screen may be first displayed irrespective of whether multi-vision regions are split, and a digital image corresponding to only a multi-vision region in which the auxiliary screen will be displayed may be then outputted with a time difference, for user convenience.

An embodiment of the present invention regarding the above example may be configured as follows.

In order to configure multi-vision image regions, the main screen device 10 manages information about the multi-vision image regions according to the number and position of detected auxiliary screen devices 20. The main screen device 10 transmits the information to auxiliary screens in the form of a UI context stream at step S126 periodically or whenever the auxiliary screen device 20 requests the information at step S203.

The auxiliary screen device 20 receives the multi-vision region information from the main screen device 10 at step S210 and produces only an image signal corresponding to its own multi-vision region by re-calibrating the image signal which is being mirrored, scaled based on the characteristic of the auxiliary screen device 20, and outputted at steps S212.

Next, the auxiliary screen device 20 is synchronized with the main screen device 10 or other auxiliary screen devices 20 or both at and S214, and it outputs the multi-vision image signal to its screen at step S216.

In a dynamic multi-vision service method using a multi-screen according to an embodiment of the present invention, image signals may be integrated and outputted to the main screen device 10 and the auxiliary screen device 20 or may be individually outputted to them.

This technology relates to a UI/UX for changing the output type of an image signal when multi-vision is configured and broadcasted. This technology includes a function of configuring a multi-vision image signal like one screen by coupling a plurality of the main screen devices 10 and the auxiliary screen devices 20 and a function of outputting a multi-vision image signal, configured like one screen and outputted, as individual images corresponding to the respective screen devices 10 and 20 according to a user's gesture.

For example, when a user takes a posture of gathering his fingers and unfolding the gathered fingers, the main screen device 10 recognizes the posture at step S114, changes an image signal shared as multi-vision into an image signal outputted to an individual screen, that is, scaling information (i.e., an individual piece of screen information) at step S120, and transmits the individual piece of screen information to the auxiliary screen device 20 in the form of a UI stream at step S126.

After receiving the information, the auxiliary screen device 20 may buffer and scale the received image signal based on its screen profile without scaling the received image signal as multi-vision at steps S206 and S208 and then may display the scaled image signal after being synchronized with other auxiliary screen devices 20 at steps S214 and S216.

In accordance with the present invention, unlike in fixed/wired type multi-vision methods controlled through intermediate signal equipment and a wireless type multi-vision method controlled using a Bluetooth module in a main display device, a multi-vision system may be easily configured through only a user's motion, that is, the same user U1/UX method in any environment.

Furthermore, in accordance with the present invention, multi-vision configuration screens are detected through UI/UX context, pieces of information about the positions and related regions of the screens are exchanged and controlled, and the pieces of information are managed in the database of a main screen terminal whenever service is configured. Accordingly, management screens may be safely reconfigured even when they are added to or separated from a multi-vision system, and thus cooperation between a main screen device and auxiliary screen devices may be implemented without being restricted to an input image signal.

Furthermore, in accordance with the present invention, an image signal between a main screen device and auxiliary screen devices is transmitted and buffered through media streaming. Accordingly, an input image signal may be outputted as a multi-vision image without being lost, and screen devices may independently display image products.

Furthermore, in accordance with the present invention, a multi-vision image may be controlled according to a user's gesture. Furthermore, when users form a group and use their smart terminals, various performances, such as that the screens of the terminals are viewed as a large-sized screen, are possible. Accordingly, the utilization of smart terminals can be increased temporally and spatially.

Furthermore, in accordance with the present invention, if IPTV or smart TV is used as a main screen device, users may enjoy multi-vision service conveniently at home or office. Accordingly, several screen devices may be freely configured according to a method desired by members and applied to digital works of art or community service applications.

Furthermore, in accordance with the present invention, a multi-vision application may be produced by using only a small smart terminal not a TV style as a main screen. If a multi-terminal, such as multi-story content, is used, convenient and personal content may be developed.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. A method of providing dynamic multi-vision service, comprising:
detecting, by a main screen device, a surrounding auxiliary screen device;
when the auxiliary screen device is detected, generating, by the main screen device, multi-vision region information defining a multi-vision image region where the main screen device and the auxiliary screen device will display an image signal;
distributing, by the main screen device, the image signal to the auxiliary screen device; and
scaling and displaying, by each of the main screen device and the auxiliary screen device, the image signal based on the multi-vision region information.

2. The method of claim 1, wherein in the scaling and displaying of the image signal, the main screen device scales an image signal to be outputted from the main screen device by the multi-vision region and displays the scaled image signal.

3. The method of claim 1, wherein in the scaling and displaying of the image signal, the auxiliary screen device calibrates the image signal, distributed by the main screen device, according to a profile of the auxiliary screen and displays the calibrated image signal.

4. The method of claim 1, further comprising recognizing, analyzing, and updating, by the main screen device and the auxiliary screen device, a type, number, and position of the main screen device and the auxiliary screen device through an object recognition function.

5. The method of claim 1, wherein a position of the auxiliary screen device is detected through a motion occurring around the main screen device based on a position of the main screen device.

6. The method of claim 1, wherein the scaling and displaying of the image signal comprises displaying, by the main screen device, the image signal in a full image form and then displaying, by the auxiliary screen device, the image signal according to the multi-vision region.

7. The method of claim 6, wherein in the scaling and displaying of the image signal, the auxiliary screen device receives the multi-vision region from the main screen device, re-calibrates the image signal according to the multi-vision region, and displays the re-calibrated image signal.

8. The method of claim 1, wherein the scaling and displaying of the image signal comprises changing a form of the image signal, outputted to the main screen device and the auxiliary screen device, according to a user's gesture.

9. The method of claim 8, wherein the main screen device and the auxiliary screen device integrate the image signals and output the integrated image signal or individually output the image signals according to the gesture.
